(19) United States
(12) Patent Application Publication
(10) Pub. No.: US 2009/0055167 A1
(43) Pub. Date: Feb. 26, 2009

(54) METHOD FOR TRANSLATION SERVICE USING THE CELLULAR PHONE

(76) Inventor: Seok-yong Moon, Seoul (KR)

Correspondence Address: IPLA P.A., 3580 WILSHIRE BLVD., 17TH FLOOR, LOS ANGELES, CA, 90010, US

(21) Appl. No.: 12/282,150

(22) PCT Filed: Mar. 15, 2006
(86) PCT No.: PCT/KR2006/000923

§ 371 Date: Sep. 8, 2008

(30) Foreign Application Priority Data
Mar. 10, 2006 (KR) 10-2006-0022499

(51) Int. Cl. G06F 17/27

(52) U.S. Cl. 704/9; 704/E17.004

(57) ABSTRACT

Disclosed is a method for providing translation service using a mobile communication terminal. The method includes a button input step of pressing a voice recognition key to use a voice recognition function, a menu screen provision step of selecting a translator menu item, a translation recognition method determination step of selecting a sentence input method or a word input method, a Korean input step of inputting Korean, a confirmation step of confirming whether a completed Korean sentence matches an intended sentence, and a translated sentence output step of providing a relevant translated sentence in a text form and reproducing the relevant translated sentence in a voice form.

### TECHNICAL FIELD

The present invention relates to a method for providing translation service using a mobile communication terminal, which is capable of translating Korean into a foreign language using a translation program installed in the terminal having a communication function.

### BACKGROUND ART

There are many cases where, when traveling abroad or meeting foreigners, one experiences many troubles with communication due to language barriers, therefore desired tasks cannot be accomplished.

Translation devices have been developed so as to solve the above-described problem, and have a, function of receiving the content of a voice in Korean, analyzing the content of a voice and then translating it into one in a desired language.

However, it is very troublesome for a user to carry a bulky and heavy translation device every day in order to communicate with foreigners.

### DISCLOSURE

### Technical Problem

Accordingly, the present invention has been made keeping in mind the above problems occurring in the prior art, and an object of the present invention is to provide a method for providing translation service using a mobile communication terminal, which is capable of translating a Korean voice, uttered by a user, into one in a foreign language using a translation program installed in the mobile communication terminal, and outputting it in a voice form through a speaker and in a text form on an Liquid Crystal Display (LCD).

### Technical Solution

In order to accomplish the above object, the present invention provides a method for providing translation service using a mobile communication terminal, including a button input step of pressing a voice recognition key on an initial screen of a mobile communication terminal to use a voice recognition function; a menu screen provision step of selecting a translator menu item on a menu selection screen on which a plurality of menu items corresponding to tasks performed using the voice recognition function are provided; a translation recognition method determination step of providing an option selection screen to allow a user to select one from among a sentence input method and a word input method when the translator menu item has been selected on the menu selection screen; a Korean input step of providing a sentence input standby screen to allow the user to input Korean using the input method selected by the user; a confirmation step of providing a confirmation screen to allow a user to confirm whether the input Korean is completed as an appropriate Korean sentence through a Korean sentence recognizer under the control of a control unit and whether the completed Korean sentence matches a sentence intended by the user; and a translated sentence output step of, if the completed sentence matches the sentence intended by the user, providing a relevant translated sentence in a text form on the screen, and, simultaneously, reproducing the relevant translated sentence in a voice form through a speaker.

Preferably, the selection of the translator menu item at the menu screen provision step, the selection of the input method at the translation recognition method determination step, the input of Korean at the Korean input step, and the confirmation of whether the completed Korean sentence matches the sentence intended by the user at the confirmation step are performed by inputting the user's voices through a microphone.

Preferably, an announcement for the selection of the translator menu item at the menu screen provision step, an announcement for the selection of the input method at the translation recognition method determination step, an announcement for the input of Korean at the Korean input step, and the confirmation of whether the completed Korean sentence matches the sentence intended by the user at the confirmation step are reproduced in a voice form through the speaker.

Preferably, the method further includes a help function selection step of, if the completed Korean sentence does not match the sentence intended by the user at the confirmation step, allowing the user to select whether to receive examples of the keyword-related sentences on the screen.

Preferably, if the help function selection step is not selected, a process returns to and performs the translation recognition method determination step.

### ADVANTAGEOUS EFFECTS

According to the present invention, there is provided a method for providing translation service using a mobile communication terminal, which is capable of translating a Korean voice, uttered by a user, into one in a foreign language using a translation program installed in the mobile communication terminal, and outputting it in a voice form through a speaker and in a text form on an LCD display, so that the user can use translation service anytime and anywhere through a mobile communication terminal, which is carried all of the time, without carrying a bulky and heavy translation device to communicate with foreigners, thereby improving the user's foreign language ability and task performance ability.

Although, in the specification, the technical spirit of the apparatus and method of providing translation service using the mobile communication terminal of the present invention is described in conjunction with the accompanying drawings, the description illustrates preferred embodiments of the present invention, and thus it is not intended to limit the present invention. Furthermore, it is apparent to those skilled in the art that various variations and modifications are possible without departing the technical spirit to the present invention.

### DESCRIPTION OF DRAWINGS

FIG. 1 is a view showing internal construction according to an embodiment of the method for providing translation service using the mobile communication terminal of the present invention.

FIG. 2 is a flowchart according to the embodiment of a method for providing translation service using the mobile communication terminal of the present invention; and

FIG. 3 is a view showing the screens of the mobile communication terminal displayed according to the flowchart of FIG. 2.

### BEST MODE

Hereinafter, a method for providing translation service using a mobile communication terminal according to the present invention is described in detail in conjunction with the accompanying drawings below.

### [Mode for Invention]

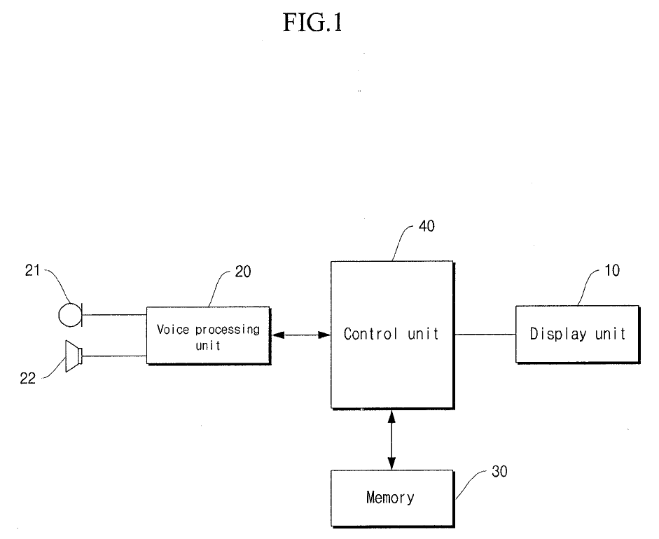

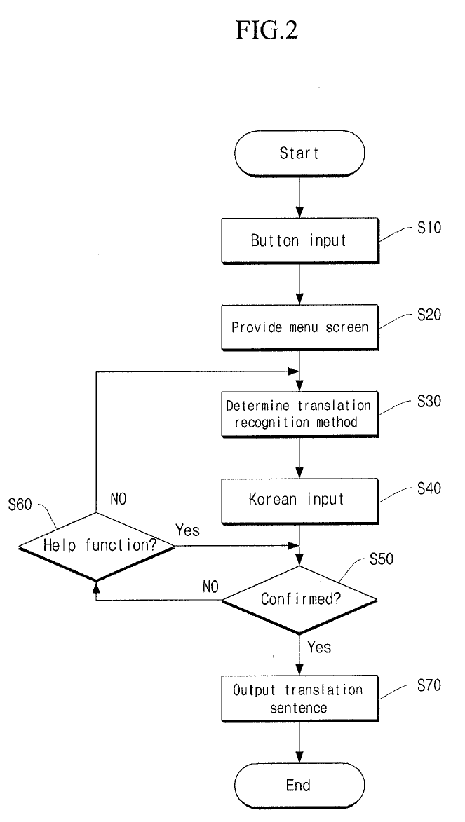

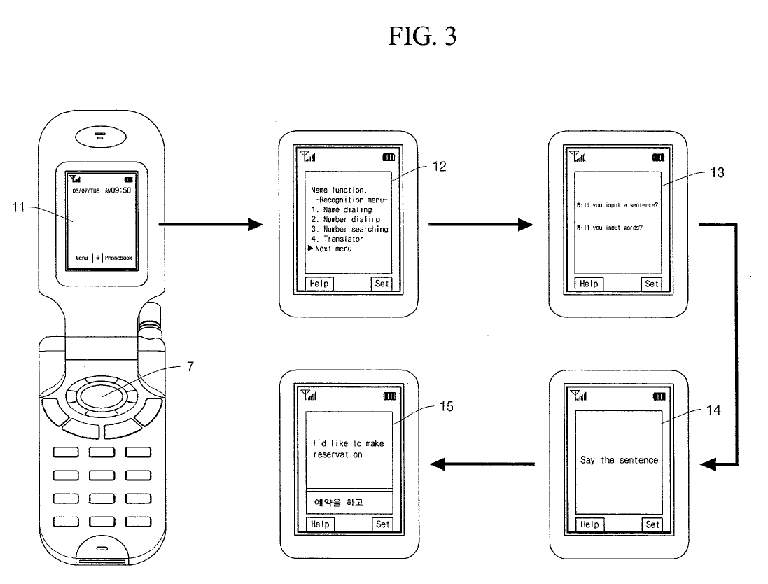

FIG. 1 is a view showing internal construction according to an embodiment of a method for providing translation service using the mobile communication terminal of the present invention, FIG. 2 is a flowchart according to the embodiment of a method for providing translation service using the mobile communication terminal of the present invention, and FIG. 3 is a view showing the screens of the mobile communication terminal displayed according to the flowchart of FIG. 2.

As illustrated in FIG. 1, an internal circuit construction according to the embodiment of a method for providing translation service using a mobile communication terminal according to the present invention includes a display unit 10, a voice processing unit 20, memory 30 and a control unit 40.

The display unit 10 is connected to the control unit 40 at one side thereof, and may be formed of a display device such as an LCD. The display unit 10 displays the state of the mobile communication terminal or the operational status of a program using graphics or moving images, and shows text corresponding to a voice, output through a speaker, under the control of the control unit 40.

The voice processing unit 20 is connected to a microphone 21 and a speaker 22 at one side thereof, and to the control unit 40 at another side thereof. The voice processing unit 20 converts a voice, transferred from the microphone 21, into a mechanical signal and provides the signal to the control unit 40. Furthermore, the voice processing unit 21 converts a mechanical signal, transferred from the control unit 40, into an analog voice and outputs it to the outside through the speaker 22.

The memory 30 is connected to one side of the control unit 40, and stores a Korean sentence recognizer and a Text to Speak (TTS) engine program that functions to convert text into sound.

The Korean sentence recognizer recognizes Korean sentences or the keywords of Korean words, and uses an n:1 sentence matching method and a keyword searching method as the recognition method thereof.

The sentence matching method recognizes a translation that matches an English sentence, as a sentence, while the keyword searching method recognizes the word of part of a translation that matches an English sentence.

The sentence chiefly includes English conversation travel sentences, for example, a Korean sentence corresponding to ‘How are you?,’ and the keyword includes Korean keywords corresponding to hotel, airport and so on.

The control unit 40 controls the overall operation of the mobile communication terminal. That is, the control unit 40 performs a task of translating a mechanical signal, that is, a user's voice that is transferred to the voice processing unit 20 and converted, using the translation method of the Korean sentence recognizer.

Furthermore, the control unit 40 outputs translated sentences through the speaker using the ITS engine program, and, at the same time, outputs relevant text through the display 10.

That is, a voice, input to the microphone 21 of the mobile communication terminal by the user to use the voice recognition function, is transferred to the voice processing unit 20, and is then converted into a mechanical signal.

The converted mechanical signal becomes command data that is recognized by the control unit 40.

That is, when a mechanical signal is command data for selecting a menu item (when the user says a ‘translator’), the menu screen of one menu item corresponding to the translator is provided. Meanwhile, when a mechanical signal is command data for Korean translation (when the user says ‘I'd like to make a hotel reservation’, or ‘hotel’ and ‘reservation’), information for input of a sentence or a word is displayed.

In this case, when the mechanical signal is a sentence or a word for translation, it is translated into a relevant foreign language by the Korean sentence recognizer by the control unit 40, and the translated sentence is output to a screen by the display unit 10.

Furthermore, the translated sentence is converted into a voice by the TTS engine program, and is output to the speaker 22 through the voice processing unit 20.

FIGS. 2 and 3 illustrate an example of use of the method for providing translation service using the communication terminal of the present invention, through a flowchart and actual screens.

As illustrated in the drawings, the method for providing translation service using the mobile communication terminal of the present invention is initiated by a button input step S10.

The standby screen 11 of FIG. 3 shows the initial screen of a general mobile communication terminal. Meanwhile, a keypad is provided with a voice recognition key 7, and thus the process proceeds to a subsequent step, that is, a menu screen provision step S20, through the button input step S10 of pressing the voice recognition key 7.

At the menu screen provision step S20, there is provided a menu selection screen 12, in which various items corresponding to tasks performed using the voice recognition function are represented.

At the same time that the menu selection screen 12 is provided, the announcement ‘name a function’ may be provided through the speaker and text corresponding to the announcement may be provided on a screen.

The announcement may be a recorded voice of a voice actor or actress, or may be output via a voice of a voice actor or actress that is obtained in such a way that the TTS engine recognizes text at the time of display of the text and converts the text into a voice.

A voice of an actor or actress to be described below may also be selected based on the method of playing back a recorded voice of a voice actor or actress or the text conversion method using a TTS engine.

In the selection of a translator menu item for translating Korean from the menu, the translator menu item may be selected by pressing a numeral button provided in the keypad of the mobile communication terminal or by saying ‘translator’ via the user's voice. When the user says ‘translator,’ the voice input through the microphone is transferred to the control unit, and thus the translator menu item can be selected in the same manner as in the case of pressing a numeral button.

When the translator menu item is selected as described above, a translation recognition method determination step S30 at which the user selects whether to input sentences or words is performed.

At the same time that the screen of the menu screen provision step S20, that is, the previous step, is changed to the option selection screen 13 of the translation recognition method determination step S30, the selection messages ‘Will you input a sentence?’ and ‘Will you input words?’ are displayed on the screen, and corresponding messages are output in a voice form through the speaker.

When the user answers by saying ‘words’, the control unit recognizes that Korean is input as words through the microphone, and the screen is converted into a screen for the next step, that is, a Korean input step S40.

At the same time that the screen is converted into a sentence input standby screen 14 for the Korean input step S40, the message ‘say words’ is provided in a text form and a corresponding message is output in a voice form through the speaker.

At this time, the user inputs keywords of the Korean sentence which he or she wishes to translate into a voice, through the microphone.

The keyword, input at the Korean input step S40 and said by the user, is completed as an appropriate Korean sentence through the Korean sentence recognizer under the control of the control unit, and then a confirmation step S50 is performed to confirm whether the completed sentence is the sentence intended by the user.

Furthermore, at this time, a relevant foreign language and the Korean sentence, input using the Korean alphabet, are displayed on a confirmation screen 15.

For example, when the user input the keywords ‘Reservation’ and ‘Hotel’ in a voice form at the Korean input step S40, the message ‘Is “Will you make a hotel reservation?” is correct?’ is output in a voice form through the speaker at the confirmation step S50. Then, if the user determines that the message is similar to the sentence intended by the user, the user answers by saying ‘Yes’; otherwise the user answers by saying ‘No’.

At this time, if the user answers by saying ‘No’ because the sentence is not similar to the sentence intended by the user, the process undergoes a help function selection step S60 at which the user selects whether the user wishes to be provided with examples of related sentences by a help function.

If the user selects the help function, various sentences corresponding to the key wards are displayed.

For example, the sentences, such as ‘Did you make a hotel reservation?’, ‘How do I make a hotel reservation?’ and ‘I'd like to cancel my hotel reservation’, are listed. At this time, if the user selects the sentence intended by him or her when the relevant sentence is present among the items, the process proceeds to the confirmation step S50 at which the user confirms whether the selected sentence is the sentence intended by the user.

Furthermore, if the user does not use the help function selection step S60, the process returns to the previous step, that is, the translation recognition method determination step S30, and selects whether the user will input a sentence or words.

At the confirmation step S50, if the user answers by saying ‘Yes’ because the displayed sentence is similar to the sentence intended by the user, the entire procedure of the method for providing translation service using the mobile communication terminal of the present invention is terminated by a translated sentence output step S70 at which the relevant translated sentence is reproduced on the screen, and, at the same time, the translated sentence is output in a voice form through the speaker.

1. A method for providing translation service using a mobile communication terminal, comprising:
a button input step (S10) of pressing a voice recognition key (7) on an initial screen of a mobile communication terminal to use a voice recognition function;
a menu screen provision step (S20) of selecting a translator menu item on a menu selection screen (12) on which a plurality of menu items corresponding to tasks performed using the voice recognition function are provided;
a translation recognition method determination step (S30) of providing an option selection screen (13) to allow a user to select one from among a sentence input method and a word input method when the translator menu item has been selected on the menu selection screen;
a Korean input step (S40) of providing a sentence input standby screen (14) to allow the user to input Korean using the input method selected by the user;
a confirmation step (S50) of providing a confirmation screen (15) to allow a user to confirm whether the input Korean is completed as an appropriate Korean sentence through a Korean sentence recognizer under control of a control unit and whether the completed Korean sentence matches a sentence intended by the user; and
a translated sentence output step (S70) of, if the completed sentence matches the sentence intended by the user, providing a relevant translated sentence in a text form on the screen, and, simultaneously, reproducing the relevant translated sentence in a voice form through a speaker.

2. The method according to claim 1, wherein the selection of the translator menu item at the menu screen provision step (S20), the selection of the input method at the translation recognition method determination step (S30), the input of Korean at the Korean input step (S40), and the confirmation of whether the completed Korean sentence matches the sentence intended by the user at the confirmation step (S50) are performed by inputting the user's voices through a microphone.

3. The method according to claim 1, wherein an announcement for the selection of the translator menu item at the menu screen provision step (S20), an announcement for the selection of the input method at the translation recognition method determination step (S30), an announcement for the input of Korean at the Korean input step (S40), and the confirmation of whether the completed Korean sentence matches the sentence intended by the user at the confirmation step (S50) are reproduced in a voice form through the speaker.

4. The method according to claim 1, further comprising a help function selection step (S60) of, if the completed Korean sentence does not match the sentence intended by the user at the confirmation step (S50), allowing the user to select whether to receive examples of the keyword-related sentences on the screen.

5. The method according to claim 4, wherein, if the help function selection step (S60) is not selected, a process returns to and performs the translation recognition method determination step (S20).
